(19) United States
(12) Patent Application Publication
(10) Pub. No.: US 2010/0321238 A1
(43) Pub. Date: Dec. 23, 2010

(54) BUTLER MATRIX AND BEAM FORMING ANTENNA COMPRISING SAME

(76) Inventor: Lin-Ping Shen, Ottawa (CA)

Correspondence Address: CHALKER FLORES, LLP, 2711 LBJ FRWY, Suite 1036, DALLAS, TX, 75234, US

(21) Appl. No.: 12/818,303

(22) Filed: Jun. 18, 2010

Related U.S. Application Data
(60) Provisional application No. 61/218,270, filed on Jun. 18, 2009.

(51) Int. Cl. H01Q 3/40

(52) U.S. Cl. 342/373

(57) ABSTRACT

The present invention provides a reduced or compact sized Butler matrix with improved performance for use in beam forming antennas and beam forming networks (BFN) applications. The reduced or compact size of the Butler matrix is enabled by shorter transmission lines between the hybrid elements as a result of using multi-layer support surfaces with substantially parallel and overlapping hybrid elements disposed thereon. Moreover, the conductive through traces of the hybrid elements have inwardly projecting and mutually approaching portions, thereby decreasing the distance between the inputs and outputs of the hybrid elements and thus reducing the size of the Butler matrix. Comparing to antennas implemented using traditional Butler matrices, antennas incorporating the present matrix can approximately reduce effective antenna area by half in bi-sector array applications, and are more suitable for complex beam forming antennas such as downtilt antennas or arrays.

### CROSS-REFERENCE TO RELATED APPLICATION

This Application relates to and claims priority to U.S. Provisional Patent Application No. 61/218,270 filed Jun. 18, 2009, entitled BUTLER MATRIX AND BEAM FORMING ANTENNA COMPRISING SAME, the entirety of which is incorporated herein by reference.

### FIELD OF THE INVENTION

The invention pertains to the field of antennas and in particular to a Butler matrix and beam forming antenna comprising same.

### BACKGROUND OF THE INVENTION

Butler matrices are generally used to create a plurality of beams for one or more antenna elements. By arranging the splitting and combining of signals using hybrid elements, a Butler matrix creates multiple beams for antenna elements or an antenna element array. Generally, an N×N Butler matrix will create N beams using N antenna elements. Thus, a 4×4 Butler matrix can be used to generate four orthogonal beams for four antenna elements. Butler matrices are capable of creating multiple beams with minimal losses and are hence useful for beam forming networks (BFN). Generally a Butler matrix comprises at least one hybrid element, which accepts two inputs and generates two outputs that are a combination of the signals at the two inputs. A hybrid element can also be referred to as a hybrid coupler or quadrature coupler. A 90 degree hybrid element outputs two signals that are shifted 90 degrees relative to each other and are generally reduced in amplitude by 3 dB because of the equal power splitting of the hybrid element. There is generally no or little energy loss in the power splitting process. Known hybrid couplers include Lange couplers, branchline couplers, overlay couplers, edge couplers and short-slot hybrid couplers, among others.

Butler matrices are of particular use in beam forming antennas. Since Butler matrices are capable of creating multiple beams with minimal losses, Butler matrix BFNs are useful in phase and amplitude adjustment of signals to be transmitted and distributed in a coherent fashion to each of the antenna elements, especially when a single antenna array is used to generate different beams.

Some known Butler matrices comprise crossovers on printed circuit boards which involve an additional photomask step, adding complexity and cost to the implementation. Some planar microwave implementations of Butler matrices avoid crossovers. However, they tend to have complicated layouts where the beam ports and element ports are located on all four sides of the circuit layout. Such complicated layouts may induce other complications when used with beam combiners, such as long transmission lines and/or crossovers required to couple to the beam combiners.

A double four-port Butler matrix etched on both sides of a suspended substrate is presented in “Low-Loss Compact Butler Matrix for Microstrip Antenna”, M. Bona, L. Manholm, J. P. Starski, and B. Svensson, IEEE Transactions on Microwave Theory and Techniques, Vol. 50, No. 9, September 2002. This bi-layer structure was adopted to solve the problem of crossover between the lines, namely by directing crossing lines on opposite sides of the suspended substrate while effectively maintaining all hybrid elements in a side-by-side arrangement as in standard single layer designs. In order to switch between sides of the suspended substrate, contactless transitions were used.

A compact waveguide Butler matrix is presented in “Compact Designs of Waveguide Butler Matrices”, J. Remez and R. Carmon, IEEE Antennas and Wireless Propagation Letters, Vol. 5, 2006. The three-dimensional waveguide Butler matrices use top-wall hybrids and short-slot hybrids. The hybrid elements are assembled from milled planar plates, with the former being vertical and the latter being horizontal. They can be constructed as one component assembled from the milled parts to save flanges and weight. The combination of top-wall and short-slot hybrid elements yields compact designs of waveguide Butler matrices with short signal path from input to output. The result is a complex three-dimensional layout with hybrid elements formed by vertical and horizontal milled plates.

These and other similar designs have various drawbacks, as will be readily apparent to a person of ordinary skill in the art. Therefore there is a need for a new Butler matrix design, and beam forming antenna comprising same, that overcomes some of the drawbacks of known technology, or alternatively, provides the public with a new and useful alternative.

The above background information is provided to reveal information believed by the applicant to be of possible relevance to the present invention. No admission is necessarily intended, nor should be construed, that any of the preceding information constitutes prior art against the invention.

### SUMMARY OF THE INVENTION

An object of the invention is to provide a Butler matrix for use in a beam forming antenna.

In accordance with one aspect of the present invention, there is provided a Butler matrix comprising: a plurality of beam ports and element ports; a plurality of hybrid elements and phase shifter elements operatively linking said beam ports and said element ports; and at least one support structure defining two or more substantially planar support surfaces, said support surfaces being substantially parallel and having disposed thereon said hybrid elements such that at least a portion of at least one of said hybrid elements disposed on one of said support surfaces at least partially overlaps at least a portion of another one of said hybrid elements disposed on another one of said support surfaces.

In accordance with another aspect of the invention, there is provided a beam forming antenna comprising at least one such Butler matrix.

In accordance with another aspect of the invention, there is provided a Butler matrix comprising: a plurality of beam ports and element ports; and a plurality of hybrid elements and phase shifter elements operatively linking said beam ports and said element ports; at least one of said hybrid elements comprising conductive traces on a substantially planar surface, said conductive traces comprising through traces for connecting two inputs and two respective outputs and two or more cross traces connecting said through traces to allow a connection of each of said inputs to each of said outputs; said through traces comprising respective inwardly projecting portions such that said through traces approach one another, thereby decreasing the distance between said inputs and said outputs.

In accordance with another aspect of the invention, there is provided a beam forming antenna comprising at least one such Butler matrix.

Since the Butler matrix board disclosed in this invention is reduced or more compact compared to usual Butler matrices due to its multilayer structure, it can help to reduce the size of the antenna for some specific applications. An example of architecture for which this Butler matrix can be useful in reduction of the size, is variable downtilt (VET) architecture. For VET applications, the implementation of Butler matrix as mentioned in this invention can cause size reduction due to the high number of required Butlers.

Other aims, objects, advantages and features of the invention will become more apparent upon reading of the following non-restrictive description of specific embodiments thereof, given by way of example only with reference to the accompanying drawings.

### BRIEF DESCRIPTION OF THE DRAWINGS

FIG. 1 is a schematic representation of a traditional Butler matrix.

FIG. 2A is a schematic representation of a two layer Butler matrix footprint, in accordance with an embodiment of the invention, showing a superimposition of the layers thereof.

FIG. 2B is a schematic representation of the two layer Butler matrix of FIG. 2A, showing respective footprints of the individual layers thereof separately.

FIG. 3 is a schematic representation of a four layer Butler matrix, in accordance with another embodiment of the invention, showing respective footprints of the individual layers thereof separately.

FIG. 4A is a schematic representation of a two layer Butler matrix footprint, in accordance with another embodiment of the invention, showing a superimposition of the layers thereof.

FIG. 4B is a schematic representation of the two layer Butler matrix of FIG. 4A, showing respective footprints of the individual layers thereof separately.

FIGS. 5A to 5C are schematic representations of different Butler matrix hybrid elements according to different embodiments of the invention.

FIGS. 6A and 6B are schematic representations of different Butler matrix hybrid elements according to different embodiments of the invention.

FIG. 7 is a schematic representation of a four layer Butler matrix, in accordance with another embodiment of the invention, showing respective footprints of the individual layers thereof separately.

FIG. 8A is a schematic representation of a two layer Butler matrix footprint, in accordance with an embodiment of the invention, showing a superimposition of the layers thereof.

FIG. 8B is a schematic representation of the two layer Butler matrix of FIG. 8A, showing respective footprints of the individual layers thereof separately.

FIG. 9A is a schematic representation of a two layer Butler matrix footprint, in accordance with an embodiment of the invention, showing a superimposition of the layers thereof.

FIG. 9B is a schematic representation of the two layer Butler matrix of FIG. 9A, showing respective footprints of the individual layers thereof separately.

FIG. 10 is a schematic representation of a high level antenna system architecture according to one embodiment of the invention.

FIG. 11 is a schematic representation of a high level antenna system architecture suitable for use with a fixed downtilt (FET) antenna system.

FIG. 12 is a schematic representation of a high level antenna system architecture suitable for use with a VET antenna system.

FIGS. 13A and 13B are schematic representations of different variable downtilt antenna systems according to different embodiments of the invention.

FIG. 14 is a schematic representation of a variable downtilt antenna system according to an embodiment of the invention.

FIG. 15 is a plot of the measured return loss of a Butler matrix according to FIG. 8.

FIGS. 16 and 17 are plots of the measured co-polarization and cross-polarization far-field azimuth array patterns, respectively, according to one embodiment of the invention.

### DETAILED DESCRIPTION OF THE INVENTION

Unless defined otherwise, all technical and scientific terms used herein have the same meaning as commonly understood by one of ordinary skill in the art to which this invention belongs.

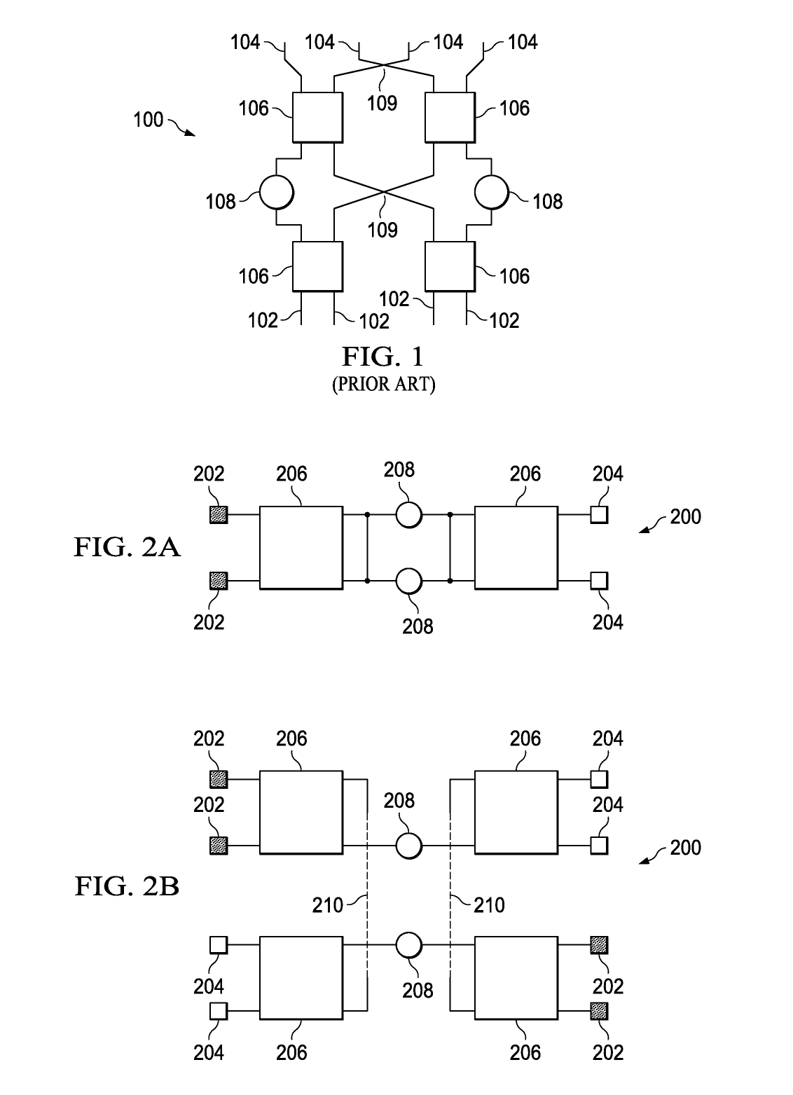

Referring to FIG. 1 and generally referred to by reference numeral 100, a traditional Butler matrix comprises four beam ports 102, four element ports 104, operatively linked by four hybrid elements 106 and two phase shifters 108. Such a traditional Butler matrix has crossovers 109.

With reference to FIGS. 2A and 2B and in accordance with one embodiment of the invention, a Butler matrix 200 is shown in schematic form. FIG. 2A shows a footprint of a superimposed two layer Butler matrix, while FIG. 2B shows a footprint of the individual layers separately, with dotted lines 210 indicating linking between the layers. The Butler matrix comprises a plurality of beam ports and element ports. In this embodiment there are four beam ports 202 and four element ports 204. The Butler matrix comprises a plurality of hybrid elements and phase shifter elements operatively linking said beam ports and said element ports. In this embodiment there are four hybrid elements 206 and two phase shifter elements 208. The Butler matrix comprises at least one support structure defining two or more substantially parallel and substantially planar support surfaces (not shown), such that at least a portion of at least one of said hybrid elements disposed on one of said support surfaces at least partially overlaps at least a portion of another one of said hybrid elements disposed on another one of said support surfaces.

In this embodiment there is one support structure defining two substantially planar support surfaces having disposed thereon four hybrid elements 206, however alternative two-layer embodiments may have two support structures defining two support surfaces. While one hybrid element may only partially overlap another hybrid element disposed on a separate surface (or another layer), in this embodiment, each of two of said four hybrid elements disposed on one of said support surfaces substantially completely overlaps a respective one of the remaining two of said four hybrid elements disposed on the other of said support surfaces to provide a compact size. In this embodiment, transmission lines between hybrid elements may be reduced in length by the overlapping hybrid element layout; if the layout instead had all hybrid elements on a single support surface, the length of transmission lines between them may need to be greater.

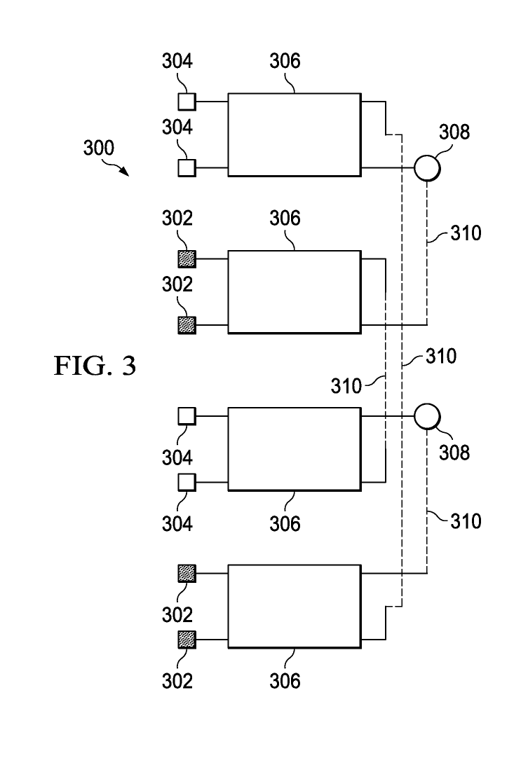

With reference to FIG. 3 and in accordance with another embodiment of the invention, a Butler matrix 300 comprises two support structures defining four substantially planar support surfaces (not shown). Alternative four-layer embodiments may have four support structures defining the four support surfaces. The support surfaces have disposed thereon four hybrid elements 306, each on one of said support surfaces, such that said four hybrid elements substantially completely overlap with each other to provide a compact size. The dotted lines 310 indicate linking between the layers. In this embodiment there are four beam ports 302 and four element ports 304. The Butler matrix comprises a plurality of hybrid elements and phase shifter elements operatively linking said beam ports and said element ports. There are four hybrid elements 306 and two phase shifter elements 308. While not shown in FIG. 3, the two support structures may be separated by a ground layer comprising at least one via therethrough. Each hybrid element has two inputs and two outputs. As previously noted, in this embodiment, transmission lines between hybrid elements may be reduced in length by the overlapping hybrid element layout.

While generally discussed here in terms of transmission operations, it will be clear to a person of skill in the art that the Butler matrix can also function in a similar fashion for reception operations. Namely, signals may be received at the element ports from respective and/or combined antenna elements in a receiving mode, wherein the relative phases of these signals are processed through the Butler matrix for consumption at the beam ports, just as signals may be received at the beam ports in a transmission mode, wherein relative phases are imparted to these signals through the Butler matrix for transmission via antenna elements operatively linked thereto.

In some embodiments of the invention, the hybrid elements on separate support surfaces are linked by vias or other such structure readily known in the art. Due to the multiple planar support surfaces, linkages such as vias are possible that can, in some embodiments, provide for stronger links and/or be more easily formed than crossovers on a single surface such as crossovers 109 in FIG. 1. Also, as will be appreciated by the person of ordinary skill in the art, the reduced and/or compact size afforded by the above described multi-layer Butler matrix designs, and others substantially equivalent thereto, will allow for greater versatility and/or applicability of these Butler matrices in different antenna system designs and/or applications.

In some embodiments the support structure is a printed circuit board. The hybrid elements and/or phase shifter elements can be at least one of deposited traces, etched traces, printed traces, and/or other suitable structure as would be apparent to a person of skill in the art. The hybrid elements can comprise at least one of microstrip line structures, strip line structures and/or other transmission line structures as would be apparent to a person of skill in the art.

In some embodiments the phase shifters delay a phase of a signal passing therethrough by 45 degrees. Other applicable phase delays will be readily apparent to the person of ordinary skill in the art depending on the application for which the Butler matrix, or antenna comprising same, is intended.

In some embodiments the hybrid elements are 90 degree hybrid elements. Other such elements will again be readily apparent to the person of ordinary skill in the art depending on the application for which the Butler matrix, or antenna comprising same, is intended.

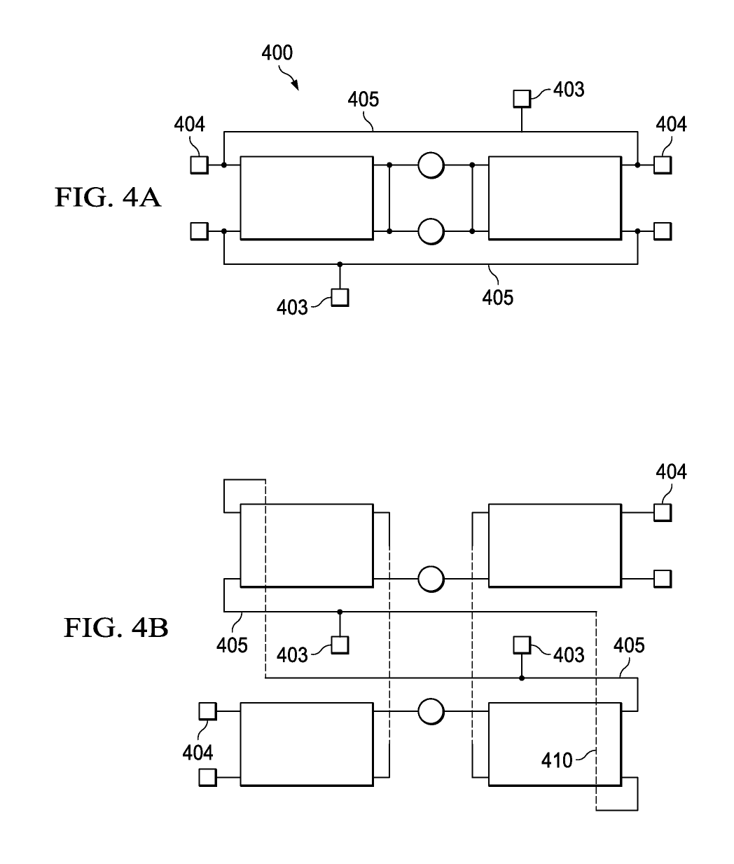

With reference to FIGS. 4A and 4B and in accordance with another embodiment of the invention, a Butler matrix generally referred to by numeral 400 is shown in schematic form. FIG. 4A shows a footprint of a superimposed two layer Butler matrix, while FIG. 4B shows respective footprints of the individual layers separately, with dotted lines 410 indicating linking between the layers. There are four element ports 404. In this embodiment the Butler matrix is part of a beam combiner network where four beams are combined to create two beams via combiners 405, yielding two combined beam ports 403. In different embodiments, different numbers of beam ports or element ports may be connected via combiners. Combiners can be of various types, such as Wilkinson dividers, as would be apparent to a person of skill in the art.

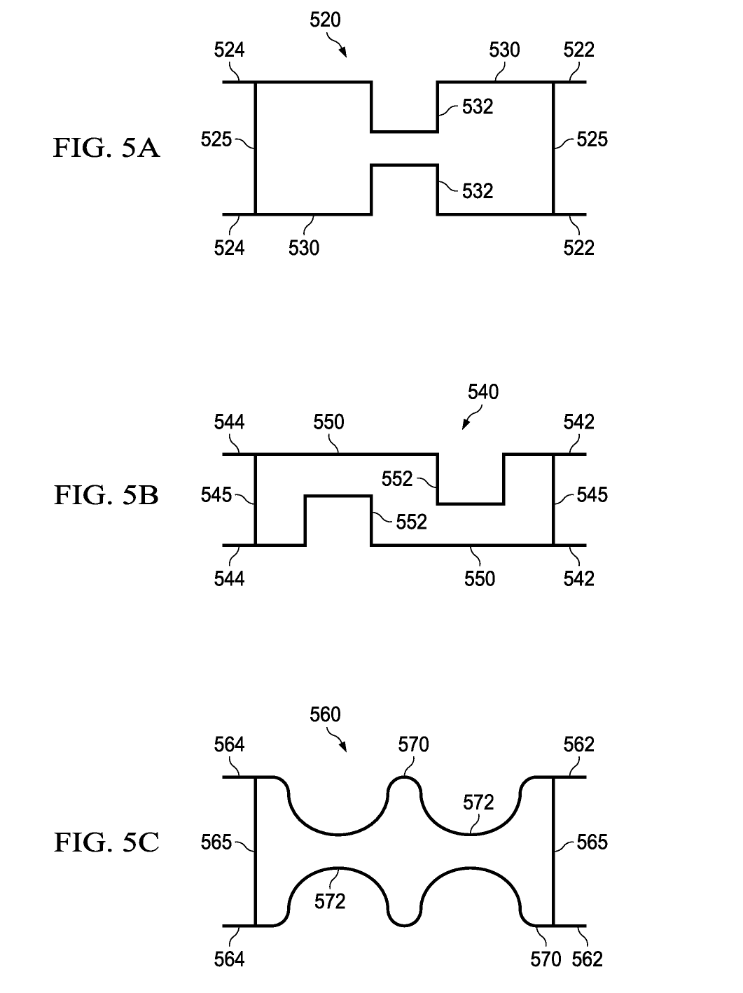

In accordance with some embodiments, a Butler matrix comprises a plurality of beam ports and element ports and a plurality of hybrid elements and phase shifter elements operatively linking said beam ports and said element port, wherein at least one of said hybrid elements comprises conductive traces on a substantially planar surface. Referring to FIGS. 5A to 5C, and in accordance with different embodiments of the invention, different examples of single branchline hybrid couplers are presented.

In FIG. 5A, the conductive traces of hybrid element 520 comprise through traces 530 for connecting two inputs 522 and two respective outputs 524, and two cross traces 525 connecting said through traces 530 to allow a connection of each of said inputs 522 to each of said outputs 524. The through traces 530 generally comprise inwardly projecting portions 532 (i.e. bent portions), such that the through traces 530 approach one another, thereby decreasing the distance between the inputs and outputs. In this embodiment the inwardly projecting portions 532 are substantially mirror images as well as being substantially aligned along the substantially planar surface.

In FIG. 5B, the conductive traces of hybrid element 540 comprise through traces 550 for connecting two inputs 542 and two respective outputs 544, and two cross traces 545 connecting said through traces 550 to allow a connection of each of said inputs 542 to each of said outputs 544. The through traces 550 generally comprise inwardly projecting portions 552 such that the through traces 550 approach one another, thereby decreasing the distance between the inputs and outputs. In this embodiment the inwardly projecting portions 552 are substantially mirror images staggered relative to one another along the substantially planar surface.

In FIG. 5C, the conductive traces of hybrid element 560 comprise through traces 570 for connecting two inputs 562 and two respective outputs 564, and two cross traces 565 connecting said through traces 570 to allow a connection of each of said inputs 562 to each of said outputs 564. The through traces 570 each generally comprise two inwardly projecting portions 572 such that the through traces 570 approach one another, thereby decreasing the distance between the inputs and outputs. In this embodiment the inwardly projecting portions 572 are substantially mirror images as well as being substantially aligned along the substantially planar surface.

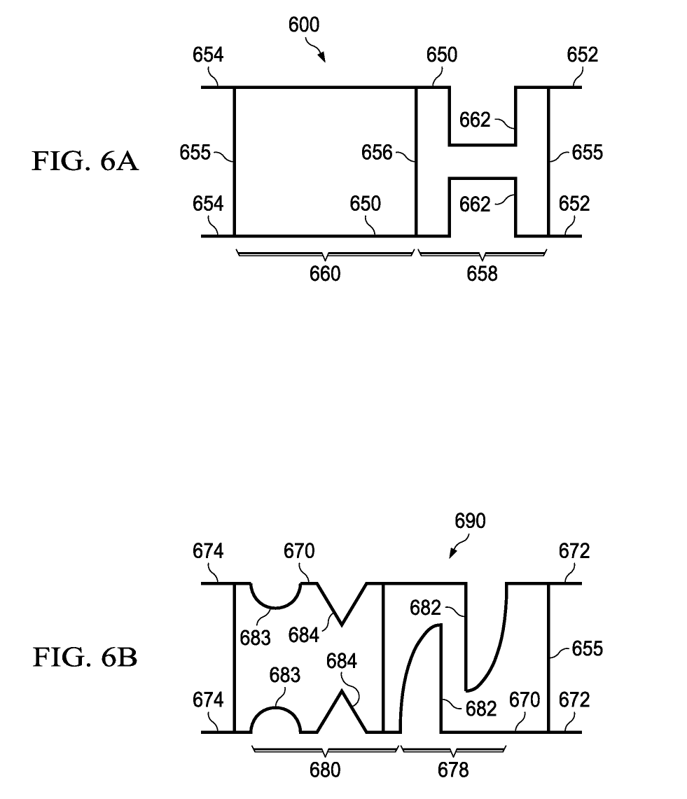

Referring to FIGS. 6A and 6B, and in accordance with different embodiments of the invention, different examples of two-stage branchline hybrid couplers are presented, which, in general, can provide for a greater overall operational bandwidth. In FIG. 6A, the conductive traces of hybrid element 600 comprise through traces 650 for connecting two inputs 652 and two respective outputs 654, and two lateral cross traces 655 and one medial cross trace 656 connecting said through traces 650 to allow a connection of each of said inputs 652 to each of said outputs 654 thereby defining an input side 658 and an output side 660 of said hybrid element on either side of said medial cross trace 656. The through traces on at least one of the input and output side comprise inwardly projecting portions 662 such that the through traces approach one another, thereby decreasing the distance between the inputs and outputs. In this embodiment the through traces on the input side 658 comprise inwardly projecting portions 662. In this embodiment the inwardly projecting portions 662 are substantially mirror images as well as being substantially aligned along the substantially planar surface.

In other embodiments, as shown for example in FIG. 6B, the inwardly projecting portions 682 are offset along the substantially planar surface. Generally, the inwardly projecting portions may have a shape that is one of substantially pointed, substantially curved, and/or a combination thereof. In hybrid element 690, inwardly projecting portions 682 on the input side 678 have a shape that is a combination of substantially curved and substantially pointed, whereas the through traces 670 on the output side 680 comprise multiple inwardly projecting portions, two substantially curved 683 and two substantially pointed 684. The inwardly projecting portions, or bent portions, can allow for a more compact overall size of the hybrid element.

It would be clear to a person of skill in the art that various shapes and sizes of inwardly projecting portions are possible, with or without symmetry, with or without alignment, and possibly in different combinations, without departing from the scope of the invention. It will be appreciated by the skilled artisan that FIG. 6B exemplifies the versatility and possible diversity of embodiments applicable within the present context. As such, while the embodiment depicted in FIG. 6B may show an unusual combination of bent portions, such unusual combinations and others alike are considered to be within the scope of the present disclosure. For example, the conductive traces can be deposited traces, etched traces and printed traces, or other suitable structure as would be apparent to a person of skill in the art. Also apparent to a person of skill in the art, the inputs can function as outputs and vice versa.

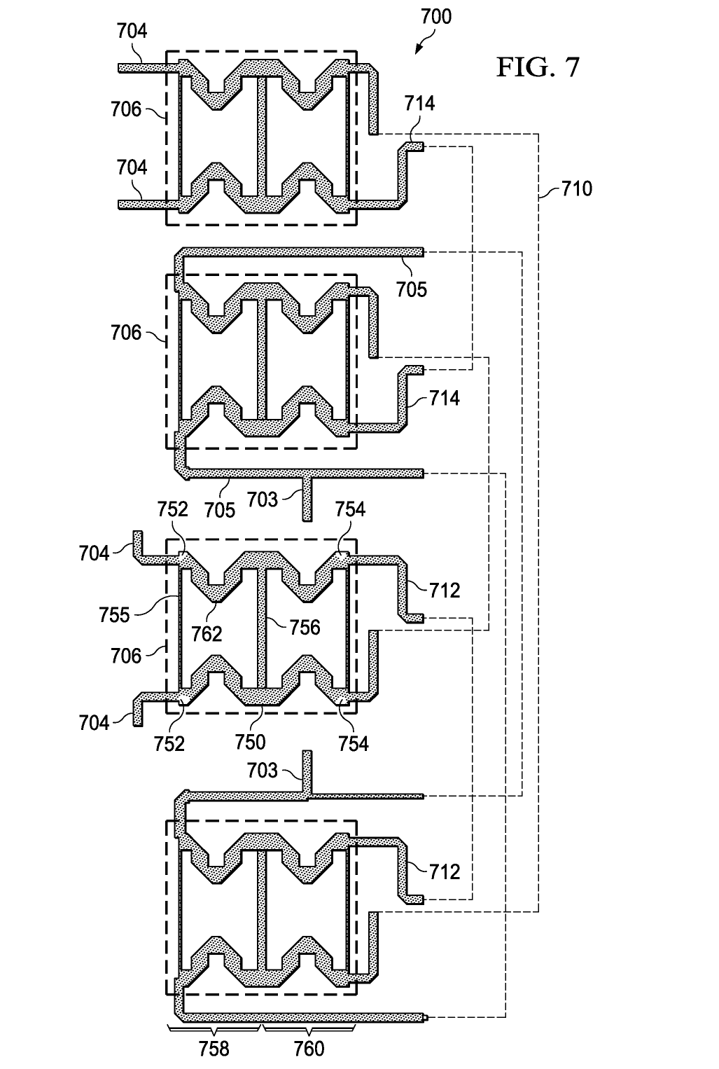

With reference to FIG. 7 and in accordance with another embodiment of the invention, a Butler matrix 700 comprises two support structures defining four substantially planar support surfaces, the support surfaces being substantially parallel and having disposed thereon the four hybrid elements such that they substantially overlap. There are four element ports 704. In this embodiment the Butler matrix is part of a beam combiner network where four beams are combined to create two beams via combiners 705, yielding two combined beam ports 703. There are four hybrid elements 706 on separate support surfaces and linked by vias (not shown). In some embodiments at least one phase shifter is disposed partially on at least two support surfaces and passes through at least one via. Here there are two phase shifters 712 and 714 disposed partially on two support surfaces and passing through vias. The four hybrid elements and two phase shifters operatively link the two combined beam ports and four element ports. The four hybrid elements comprise conductive traces comprising through traces 750 for connecting two inputs 752 and two respective outputs 754 and edge and medial cross traces 755 and 756 respectively, connecting said through traces 750 to allow a connection of each of the inputs to each of the outputs and thereby defining an input side 758 and an output side 760 of the hybrid element on either side of the medial cross trace 756. In this embodiment the through traces on both the input side and output side comprise inwardly projecting or bent portions 762 that project inwardly such that said through traces approach one another, thereby decreasing the distance between said inputs and said outputs. Embodiments such as this one, where the Butler matrix both comprises hybrid elements disposed on two or more support surfaces and comprises a hybrid element comprising bent portions on the through traces, can be used to obtain a compact size that is enabled by both the multilayer structure and the bent portions decreasing the distance between the inputs and outputs of a hybrid element(s).

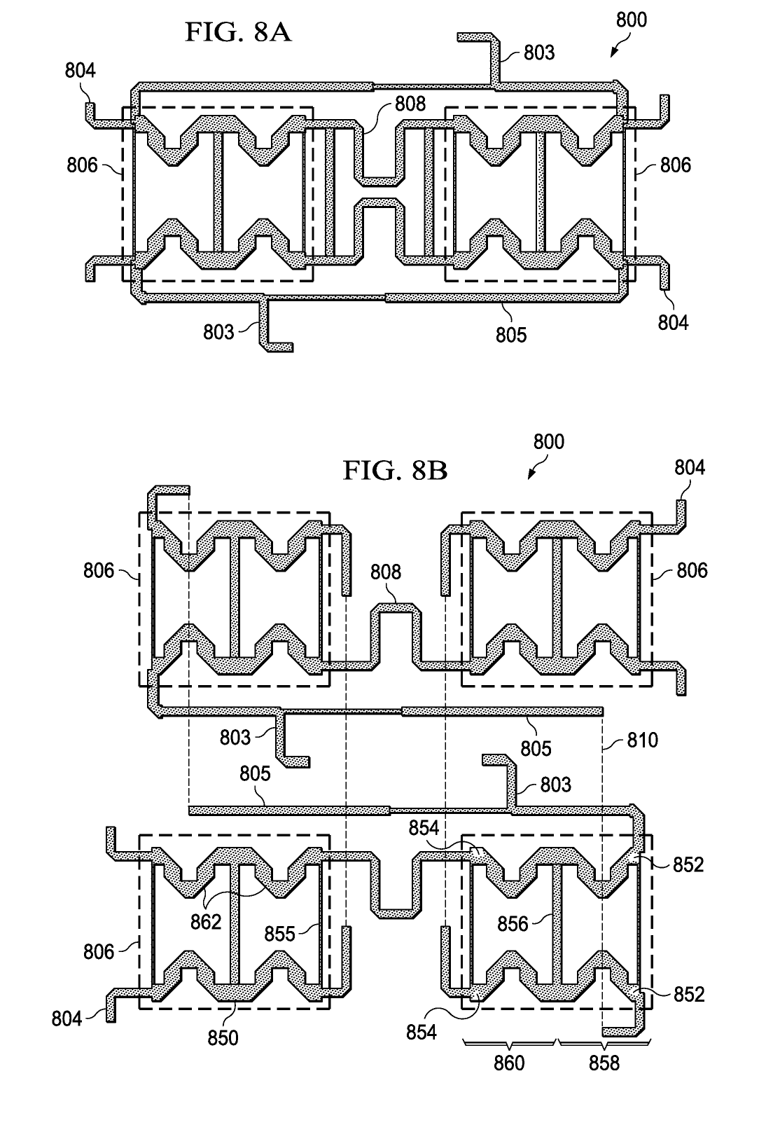

With reference to FIGS. 8A and 8B and in accordance with another embodiment of the invention, a Butler matrix 800 is shown in schematic form. FIG. 8A shows a footprint of a superimposed two layer Butler matrix, while FIG. 8B shows respective footprints of the individual layers separately, with dotted lines 810 indicating linking between the layers. The Butler matrix 800 generally comprises four hybrid elements 806, two phase shifters 808 and four element ports 804. In this embodiment the Butler matrix is part of a beam combiner network where four beams are combined to create two beams via combiners 805, yielding two combined beam ports 803.

In this embodiment, the Butler matrix 800 generally comprises one support structure (not shown) defining two substantially planar support surfaces, the support surfaces being substantially parallel and having disposed thereon the four hybrid elements 806 such that each of two hybrid elements disposed on one of said support surfaces substantially completely overlaps a respective one of the remaining two hybrid elements disposed on the other of said support surfaces to provide a compact size. The hybrid elements 806 on separate support surfaces are generally linked by vias (not shown) or other such structures readily known in the art.

In this embodiment, each of the four hybrid elements comprises conductive traces comprising through traces 850 for connecting two inputs 852 and two respective outputs 854, and edge and medial cross traces 855 and 856 respectively, connecting said through traces 850 to allow a connection of each of the inputs to each of the outputs, and thereby defining an input side 858 and an output side 860 of the hybrid element on either side of the medial cross trace 856. In this embodiment the through traces on both the input side and output side comprise inwardly projecting or bent portions 862 such that said through traces approach one another, thereby decreasing the distance between said inputs and said outputs.

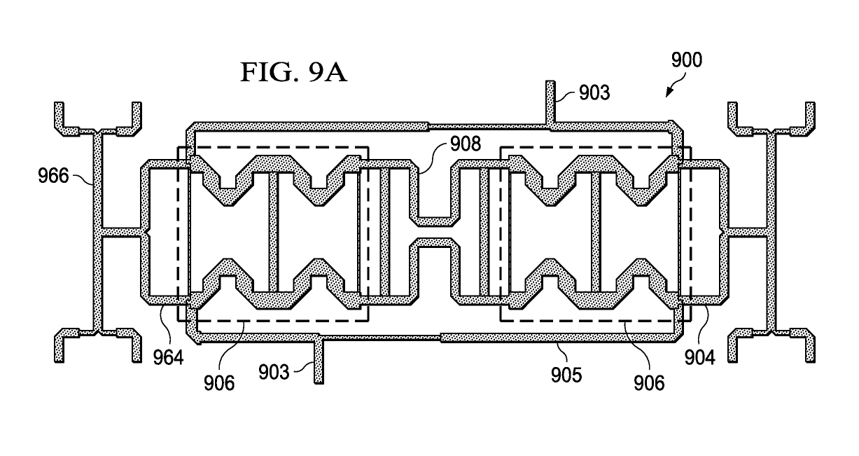

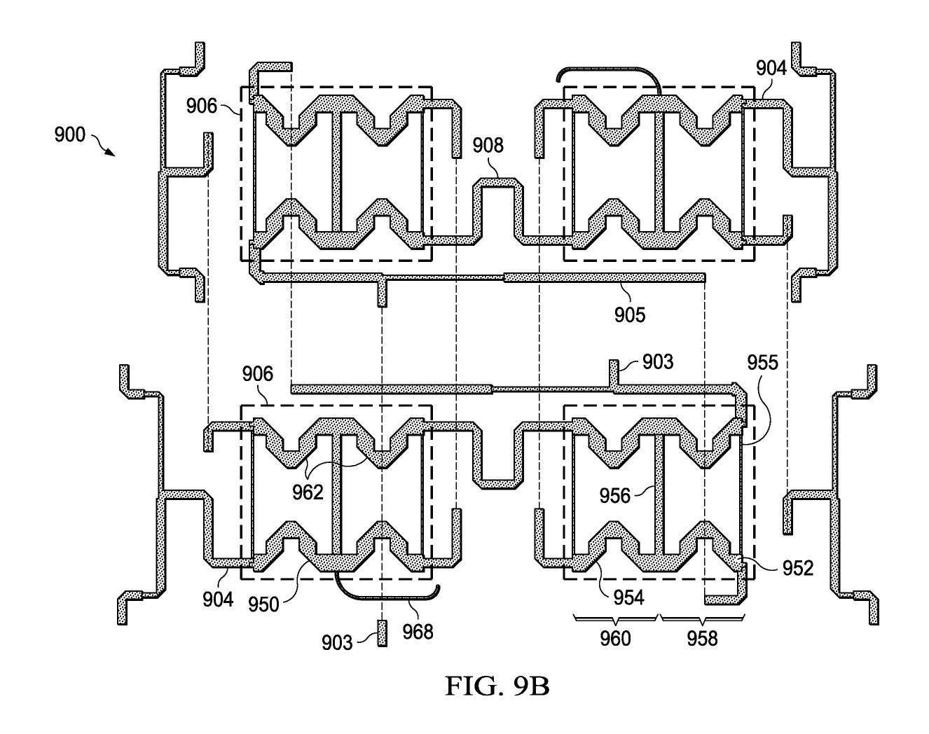

With reference to FIGS. 9A and 9B and in accordance with another embodiment of the invention, a Butler matrix 900 is shown in schematic form. FIG. 9A shows a footprint of a superimposed two layer Butler matrix, while FIG. 9B shows respective footprints of the individual layers separately, with dotted lines 910 indicating linking between the layers.

The Butler matrix 900 generally comprises one support structure defining two substantially planar support surfaces, the support surfaces being substantially parallel and having disposed thereon four hybrid elements 906 such that each of two hybrid elements disposed on one of said support surfaces substantially completely overlaps a respective one of the remaining two hybrid elements disposed on the other of said support surfaces to provide a compact size. There are four element ports 904. In this embodiment the Butler matrix is part of a beam combiner network where four beams are combined to create two beams via combiners 905, yielding two combined beam ports 903. There are two phase shifters 908. The four hybrid elements 906 on separate support surfaces may be linked by vias (not shown) or the like. The four hybrid elements 906 and two phase shifters 908 operatively link the two combined beam ports 903 and four element ports.

In this embodiment, the four hybrid elements 906 comprise conductive traces comprising through traces 950 for connecting two inputs 952 and two respective outputs 954, and edge and medial cross traces 955 and 956 respectively, connecting said through traces 950 to allow a connection of each of the inputs to each of the outputs, and thereby defining an input side 958 and an output side 960 of the hybrid element on either side of the medial cross trace 956. In this embodiment the through traces on both the input side and output side comprise bent portions 962 that project inwardly such that said through traces approach one another, thereby decreasing the distance between said inputs and said outputs.

In this embodiment there are two DC grounds 968 (shown only in FIG. 9B). The Butler matrix is linked to two T-splitters 964 and two 1×4 connectors 966 for linking to antenna elements. In this manner the Butler matrix according to some embodiments can be integrated with an elevation beam forming network such that no traditional elevation BFN boards are needed and the number of joint connections may be reduced. In some embodiments this elevation beam forming network can be used to simplify the architecture of a fixed downtilt beam forming antenna. As would be apparent to a person of skill in the art, different embodiments may use T-splitters with varying leg lengths so as to adjust the phase relationship between the signal entering each of the beam ports, while the amplitude of the signals entering each of the beam ports may be adjusted by varying the width of the legs of the T-splitter.

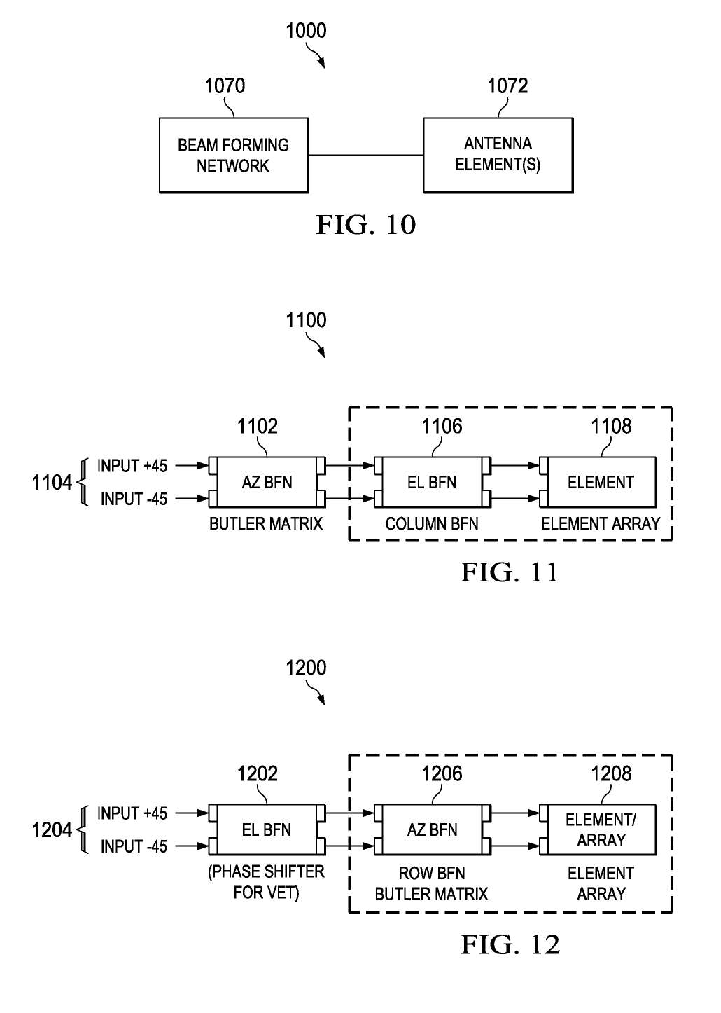

As will be appreciated by the person of ordinary skill in the art, while the embodiments of FIGS. 7 to 9 each comprise hybrid elements comprised of two-stage branchline hybrid couplers, each one of which comprising substantially mirror image and aligned inwardly projecting or bent portions, similar embodiments comprising different types of hybrid elements, such as those shown in FIGS. 5 and 6, comprising different sizes, shapes and/or combinations of inwardly projecting or bent through trace portions, or being devoid of any inwardly projecting or bent portions, may be considered herein without departing from the general scope and nature of the present disclosure. Furthermore, it will be appreciated that any of the above embodiments, and equivalents thereto, may be considered herein for the manufacture and operation of a beamforming antenna system, as described below with reference to FIGS. 10 to 14.

With reference to FIG. 10, an antenna, generally referred to by numeral 1000 and in accordance with one embodiment of the invention, comprises an antenna element or an array of antenna elements 1072 and at least one beam forming network (BFN) 1070 operatively linked to the array of antenna elements 1072. In the present context, at least one of the beam forming networks comprises a Butler matrix incorporating at least one of the novel features described herein, for example as described above with reference to the exemplary embodiments of FIGS. 2 to 9, to transmit a signal received at a beam port thereof to at least one of said array of antenna elements via a respective element port. The signal may also be transmitted through further BFNs en route to the array of antenna elements.

In some embodiments, the BFN 1070 can be separate from, or partially or fully integrated with the antenna element 1072, and can comprise an azimuth BFN or an elevation BFN, or both. In embodiments where both the azimuth BFN and the elevation BFN are comprised in the BFN, one of said azimuth BFN and said elevation BFN, or both, can be integrated with the array of antenna elements. One or more BFNs may also comprise a wideband T-splitter with or without phase delay, as will be readily understood by the person of skill in the art.

By incorporating one or more Butler matrices as described above, for example with reference to the different exemplary embodiments of FIGS. 2 to 9, in the BFN of a beam forming antenna, for example, the reduced or compact size afforded by the design of such matrices can facilitate and/or enable operation of such antenna as a fixed downtilt antenna or array, a variable downtilt antenna or array, and/or a remote downtilt antenna or array (i.e. remote variable downtilt control). Namely, while traditional Butler matrix designs are generally not conducive to implementing such variability or complexity in a beam forming antenna, most often due to their overall size or reduced operating characteristics, the above-described and other such embodiments of the inventive Butler matrix designs considered herein can provide for various operational advantages over known designs, which in some embodiments, allow for their effective use in various BFN applications and antenna systems.

As will be appreciated by the person of skill in the art, a BFN incorporating such a Butler matrix design may be integrated into compact circuits based on thin-film or other types of integrated circuits.

Furthermore, the antenna element(s) in a given antenna array or system can, in different embodiments, comprise one or more dipoles, capacitive-coupled patches, slot-coupled patches (SCP), and/or other suitable elements readily known in the art.

Also, hybrid couplers, T-splitters and connection lines considered in different embodiments can comprise, for example, microstrip line structures, strip line structures and/or other suitable transmission line structures readily known in the art.

In addition, a BFN of a given embodiment can be operatively linked to the antenna element(s) to drive said element(s); in some embodiments it is an azimuth BFN that drives the element(s), while in some other embodiments it is an elevation BFN that drives the element(s). In some embodiments, at least one of the BFNs is a beam combiner network.

As described above, incorporation in a BFN of a Butler matrix designed consistent with one or more of the inventive features described above, for example as exemplified by the illustrative embodiments depicted in FIGS. 2 to 9, can in some embodiments provide for a simplified and/or more effective beam forming antenna architecture. In some embodiments, the reduced and/or compact size of the incorporated Butler matrices may lead to reduced losses and/or reduced phase error common in traditional Butler matrices due to long transmission lines, for example, between hybrid elements and T splitters; such incorporation may thus improve the overall performance of the antenna. In some embodiments the compact size of a BFN comprising such a Butler matrix is advantageous for use in a variable downtilt antenna, for instance, wherein a variable downtilt antenna could not otherwise be effectively constructed using known Butler matrix technology. These and other such advantages, as well as different applications not specifically addressed herein but equally relevant to the present context, will be readily appreciated by the person of ordinary skill in the art and therefore, should not be considered to depart from the general scope and nature of the present disclosure.

In some embodiments, one or more features of the above-described Butler matrix designs are applied in a bi-sector antenna array application. In general, a bi-sector antenna array comprises a planar antenna array with few columns (normally three, four, or six) and high excitation ratios. A BFN comprising a Butler matrix can generally allow for multiple beams with shared elements. For bi-sector applications, the effective antenna area can be halved by using a Butler BFN rather than a traditional BFN, particularly when considering different embodiments of the Butler matrices considered herein. In considering appropriate Butler matrix design, one notes that return loss and isolation between two polarizations of the BFN can play an important role in the array performance, which considerations can be accounted for in designing specific embodiments of the herein-described Butler matrix designs. It will be appreciated that while a BFN comprising a Butler matrix as presented herein may be useful in the context of a bi-sector array, for instance due to their potentially reduced and/or compact size given the limited space available in a bi-sector array system, use of such designs and BFNs can also be beneficial for other types of antennas and antenna arrays and therefore, should not be construed to be limited as such.

With reference to FIG. 11 and according to another embodiment of the invention, an antenna system architecture suitable for use with a fixed downtilt bisector antenna array is generally referred to by the numeral 1100. Here a Butler matrix, for example as described above with reference to the illustrative embodiments of FIGS. 2 to 9, is comprised by an azimuth BFN 1102 that receives two inputs 1104. The azimuth BFN is linked to an elevation BFN 1106 comprising a column BFN. The elevation BFN is integrated with the element and/or element array 1108. The azimuth beam shaping can be changed, for example, by changing the azimuth BFN. While useful for variable tilt applications, this architecture can be particularly well suited for fixed tilt applications.

With reference to FIG. 12 and according to another embodiment of the invention, an architecture suitable for use with a variable downtilt bisector antenna array is generally referred to by numeral 1200. Here a Butler matrix, for example as described above with reference to the illustrative embodiments of FIGS. 2 to 9, is used as an azimuth (AZ BFN) 1206 to control the azimuth beam pattern of the antenna system. Accordingly, an elevation BFN 1202 receives two inputs 1204, which feeds the Butler matrix implemented azimuth BFN 1206. In this embodiment, the azimuth BFN 1206 is integrated with the element and/or element array 1208. While useful for fixed tilt applications, this architecture can be particularly well suited for variable tilt applications.

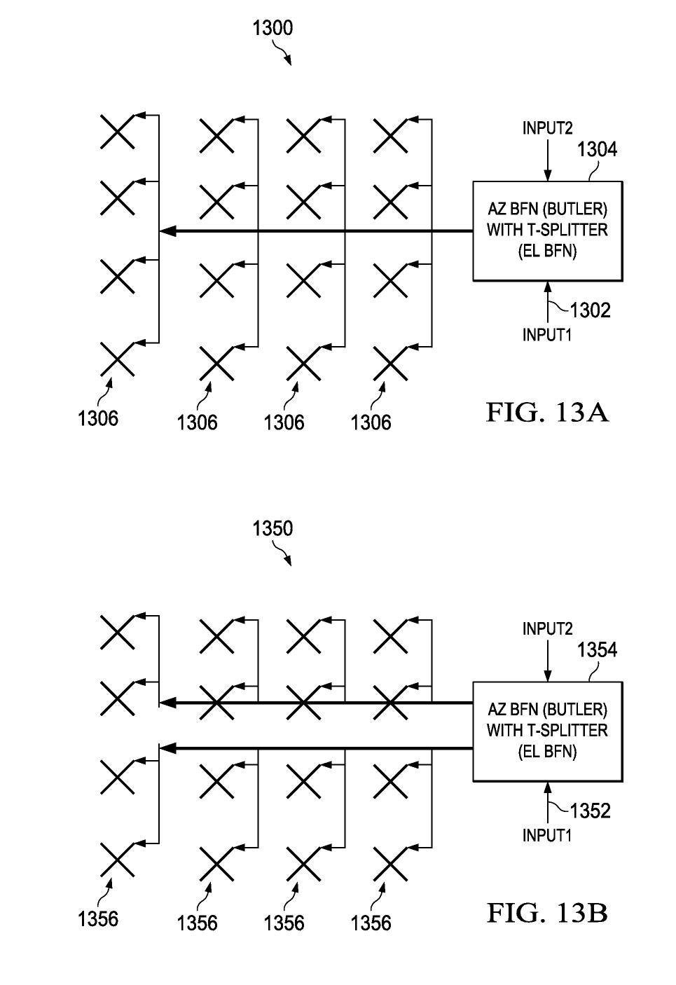

With reference to FIGS. 13A and 13B and in accordance with various embodiments of the invention, partial schematic representations of fixed electrical down-tilted (FET) antennas are presented. In FIG. 13A, a FET antenna 1300 is partially schematically illustrated, wherein two inputs 1302 are provided to a Butler matrix implemented AZ BFN 1304, which generally comprises a 2-to-4 BFN (for example as shown in FIGS. 4, 7 and 8) and a T-Splitter (not shown in those Figures) operating at least in part as an EL BFN, which drives a series of antenna elements 1306. In FIG. 13B, a FET antenna 1350 is partially schematically illustrated, wherein two inputs 1352 are provided to a Butler matrix implemented AZ BFN 1354, which generally comprises a 2-to-8 BFN (for example as shown in FIG. 9) and a T-Splitter (e.g. splitter 964 of FIG. 9) operating at least in part as an EL BFN, which drives a series of antenna elements 1356. Note that only two inputs are shown in each of these embodiments, however, as will be appreciated by the person of ordinary skill in the art, four input ports will generally be utilised in a dual polarization bi-sector array application. These and other such applications should be readily apparent to the person of ordinary skill in the art, and are therefore not meant to depart from the general scope and nature of the present disclosure.

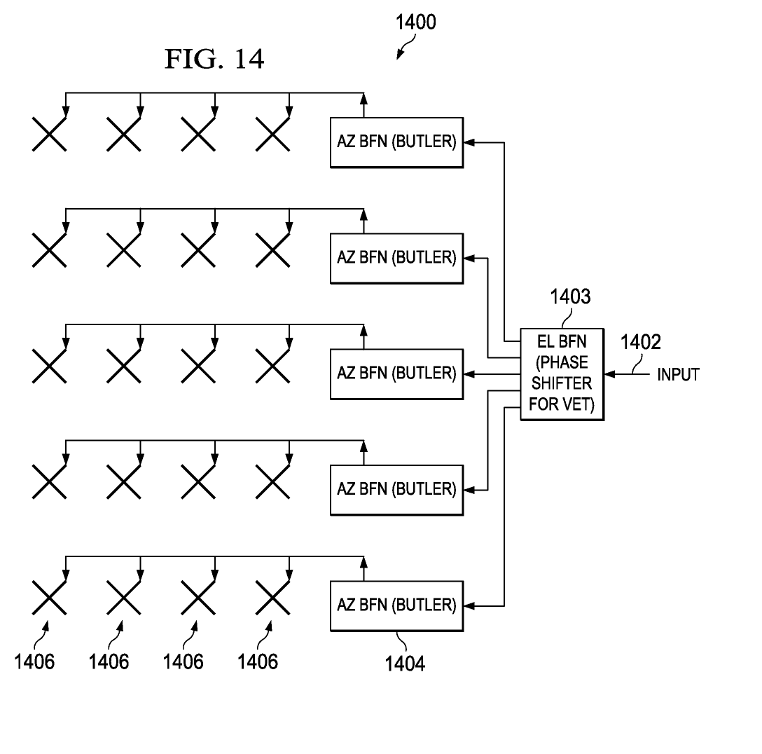

With reference to FIG. 14, and in accordance with one embodiment of the invention, a partial schematic representation of a variable down tilt antenna (VET) 1400 is presented. In this embodiment, each input 1402 is first past through a 1-to-5 EL BFN 1403 which then links to respective Butler matrix-implemented AZ BFNs 1404 (e.g. as shown in FIGS. 4, 7 and 8), which drive the antenna elements 1406 disposed on five four-element sub-arrays.

In one embodiment of the invention, the VET antenna system of FIG. 14 is configured for operation as a dual polarization bi-sector array antenna system. For example, in one such embodiment, four inputs are linked to respective 1-to-5 EL BFNs, each operatively linked to 5 pairs of Butler-matrix implemented AZ BFNs provided on 5 eight-antenna-element printed circuit boards (PCB), wherein each pair of Butler matrices may be configured to drive an eight-antenna-element sub-array of the antenna system. It will be appreciated by the person of ordinary skill in the art that other antenna configurations and/or applications may be considered herein, for example by combining different groups and/or subgroups of elements as described illustratively herein, to provide a desired effect, without departing from the general scope and nature of the present disclosure.

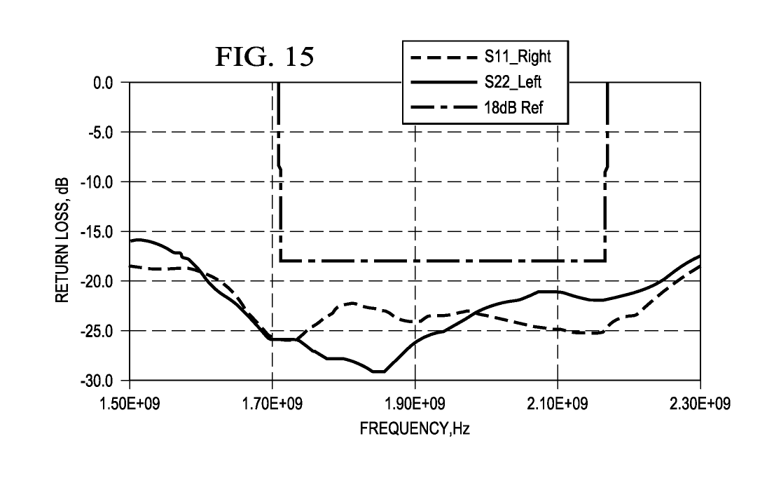

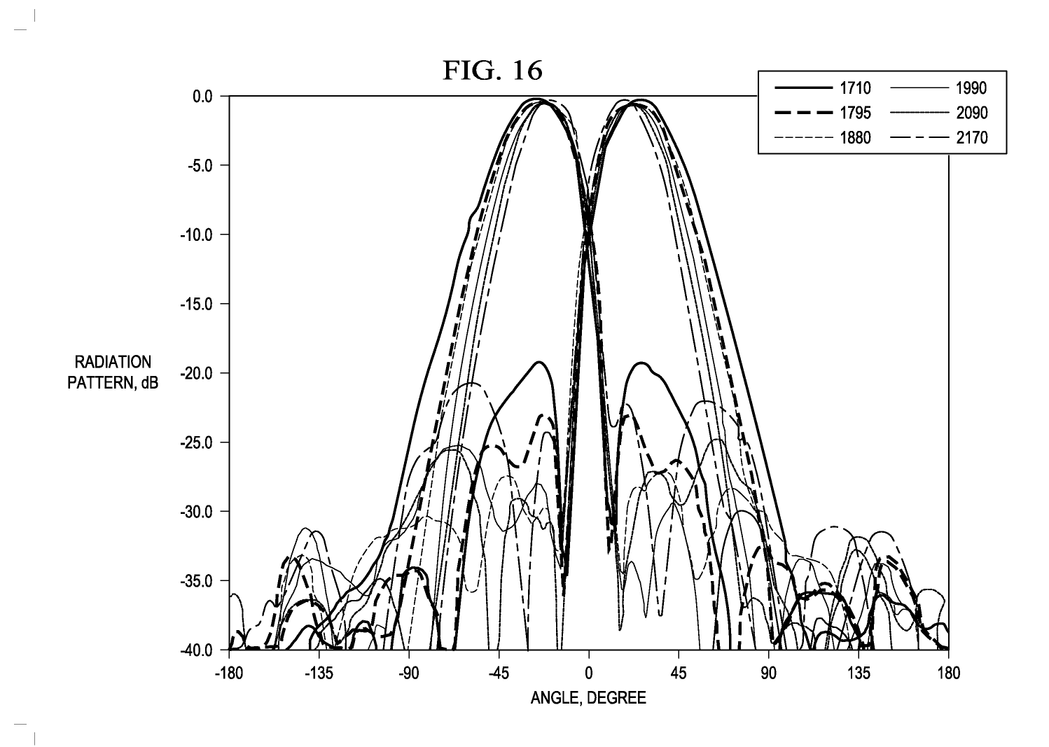

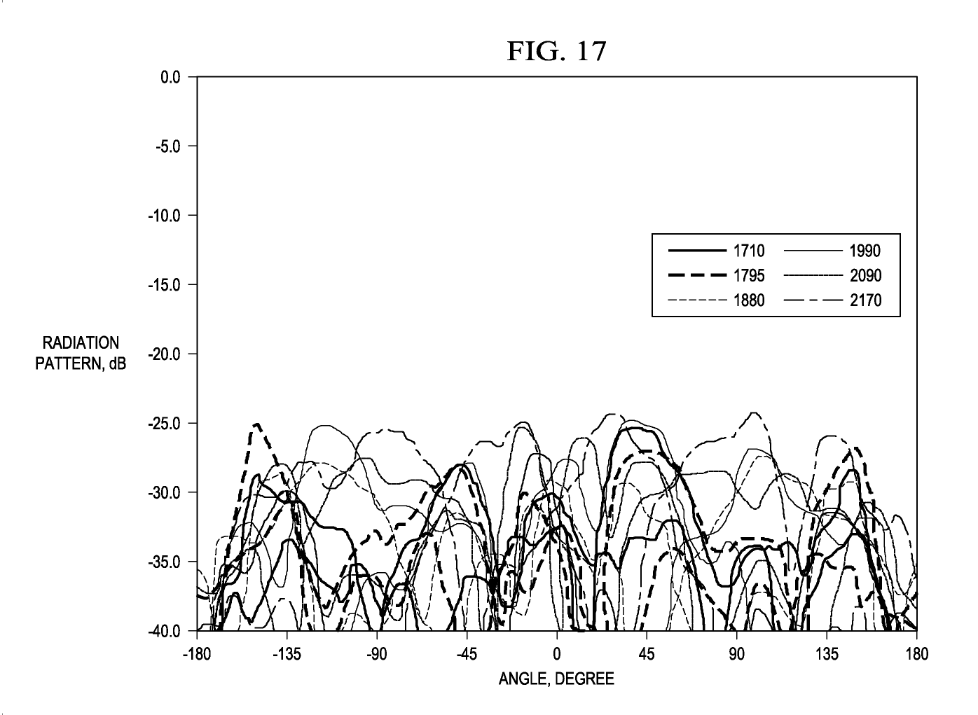

FIG. 15 is a plot of the return loss of a Butler matrix according to FIG. 8. FIGS. 16 and 17 are plots of the measured co-polarization and cross-polarization far-field azimuth array patterns of a 4×10 array at a 4 degree down-tilt angle, in which dual polarization slot-coupled antenna elements are used and operatively driven through such Butler matrices. From these plots, it is observed that the azimuth sidelobe level (SLL) is lower than 20 dB and the cross-polarization discrimination (XPD) is lower than 25 dB.

It is apparent that the foregoing embodiments of the invention are exemplary and can be varied in many ways. Such present or future variations are not to be regarded as a departure from the spirit and scope of the invention, and all such modifications as would be apparent to one skilled in the art are intended to be included within the scope of the following claims.

1. A Butler matrix comprising:
a plurality of beam ports and element ports;
a plurality of hybrid elements and phase shifter elements operatively linking said beam ports and said element ports; and
at least one support structure defining two or more substantially planar support surfaces, said support surfaces being substantially parallel and having disposed thereon said hybrid elements such that at least a portion of at least one of said hybrid elements disposed on one of said support surfaces at least partially overlaps at least a portion of another one of said hybrid elements disposed on another of said support surfaces.

2. The Butler matrix of claim 1, wherein said at least one support structure comprises a single support structure defining two substantially planar support surfaces, said support surfaces having disposed thereon four hybrid elements such that each of two of said four hybrid elements disposed on one of said support surfaces substantially completely overlaps a respective one of the remaining two of said four hybrid elements disposed on the other of said support surfaces.

3. The Butler matrix of claim 1 comprising two phase shifters each providing a phase delay of about 45 degrees.

4. The Butler matrix of claim 1, wherein hybrid elements on separate support surfaces are linked by vias.

5. The Butler matrix of claim 1, wherein said support structure comprises a printed circuit board substrate.

6. The Butler matrix of claim 1, wherein at least one of said hybrid elements and said phase shifter elements comprises at least one of deposited traces, etched traces and printed traces.

7. The Butler matrix of claim 1, comprising four said hybrid elements and at least two said support structures defining four said substantially planar support surfaces, each of said support surfaces having respectively disposed thereon one of said hybrid elements such that all said hybrid elements substantially completely overlap.

8. The Butler matrix of claim 1, wherein at least one of said phase shifters is partially disposed on at least two of said support surfaces.

9. The Butler matrix of claim 1, wherein transmission lines between hybrid elements are reduced in length by hybrid element overlap.

10. The Butler matrix of claim 1, wherein at least one of said hybrid elements comprises at least one of a microstrip line structure and a strip line structure.

11. The Butler matrix of claim 1, wherein:
at least one of said hybrid elements comprises conductive traces comprising through traces for connecting two hybrid inputs and two respective hybrid outputs and two or more cross traces connecting said through traces to allow a connection of each of said hybrid inputs to each of said hybrid outputs; and
said through traces comprising respective inwardly projecting portions such that said through traces approach one another, thereby decreasing the distance between said hybrid inputs and said hybrid outputs.

12. The Butler matrix of claim 11, said at least one of said hybrid elements comprising a two stage branchline hybrid element comprising three cross traces, a medial one of which defining an input side and an output side of said at least one of said hybrid elements, said through traces comprising said respective inwardly projecting portions on at least one of said input side and said output side.

13. A Butler matrix comprising:
a plurality of beam ports and element ports; and
a plurality of hybrid elements and phase shifter elements operatively linking said beam ports and said element ports;
at least one of said hybrid elements comprising conductive traces on a substantially planar surface, said conductive traces comprising through traces for connecting two inputs and two respective outputs and two or more cross traces connecting said through traces to allow a connection of each of said inputs to each of said outputs; and
said through traces comprising respective inwardly projecting portions such that said through traces approach one another, thereby decreasing the distance between said inputs and said outputs.

14. The Butler matrix of claim 13, wherein said through traces comprise multiple inwardly projecting portions.

15. The Butler matrix of claim 13, wherein said inwardly projecting portions are substantially mirror image.

16. The Butler matrix of claim 13, wherein said inwardly projecting portions comprise at least one of a substantially pointed portion and substantially curved portion.

17. The Butler matrix of claim 13, wherein an alignment of said inwardly projecting portions is one of substantially aligned and offset, along said substantially planar surface.

18. The Butler matrix of claim 13, wherein the conductive traces are at least one of deposited traces, etched traces and printed traces.

19. The Butler matrix of claim 13, said at least one of said hybrid elements comprising a two stage branch line hybrid element comprising three cross traces, a medial one of which defining an input side and an output side of said at least one of said hybrid elements, said through traces comprising said respective inwardly projecting portions on at least one of said input side and said output side.

20. A beam forming antenna comprising:
an array of antenna elements; and
a beam forming network operatively linked to said array of antenna elements, said beam forming network comprising at least one Butler matrix as in claim 1.

21. The beam forming antenna of claim 20, wherein:
at least one of said hybrid elements of said at least one Butler matrix comprises conductive traces comprising through traces for connecting two hybrid inputs and two respective hybrid outputs and two or more cross traces connecting said through traces to allow a connection of each of said hybrid inputs to each of said hybrid outputs; and
said through traces comprising respective inwardly projecting portions such that said through traces approach one another, thereby decreasing the distance between said hybrid inputs and said hybrid outputs.

22. The beam forming antenna of claim 20, wherein said beam forming antenna comprises one of a fixed downtilt antenna, a remote downtilt antenna and a variable downtilt antenna.

24. The beam forming antenna of claim 20, wherein said array of antenna elements comprises at least one of dipole elements, capacitive-coupled patch elements and slot-coupled patch elements.

25. The beam forming antenna of claim 20, wherein said at least one Butler matrix is operated as an azimuth beam forming network.
